(19) United States
(12) Patent Application Publication
(10) Pub. No.: US 2010/0052939 A1
(43) Pub. Date: Mar. 4, 2010

(54) Lighting System and Related Method Capable of Reducing Electricity Consumption

(76) Inventor: Po-Hsiang Liang, Taipei Hsien (TW)

Correspondence Address: NORTH AMERICA INTELLECTUAL PROPERTY CORPORATION, P.O. BOX 506, MERRIFIELD, VA, 22116, US

(21) Appl. No.: 12/475,608

(22) Filed: Jun. 1, 2009

(30) Foreign Application Priority Data
Sep. 1, 2008 (TW) 097133466

(51) Int. Cl. G08C 19/00; H04M 1/00

(52) U.S. Cl. 340/825.72; 455/556.2

(57) ABSTRACT

A lighting system capable of reducing electricity consumption includes a switch device, a mobile communication device and a control device. The mobile communication device includes a position detection module for detecting a position to generate a position data, a light sensing module for detecting luminance to generate a light sensing data, a wireless transmission module for wirelessly outputting data, and a first processing module for transmitting the position data and the light sensing data to the air via the wireless transmission module. The control device includes a wireless reception module for receiving the position data and the light sensing data, and a second processing module for outputting a control command to the switch device according to the position data and the light sensing data, to control a twinkle state of a related lighting device.

### Background of the Invention

1. Field of the Invention

The present invention relates to a lighting system and related method capable of reducing electricity consumption, and more particularly, to a lighting system and related method avoiding unnecessary electrical consumption, so as to reduce electricity consumption and enhance convenience.

2. Description of the Prior Art

Energy is a force driving economy development in any country, and is indispensable for enhancing people's living standard. In all energies, “electricity” has characteristics of clean, high efficiency and facile conduction. Therefore, in a time of advanced technology and high living standard, electricity becomes more and more important. However, electricity cannot be obtained steadily from the nature. In other words, electricity needs to be obtained by energy transformation, such as transformation heat energy to electricity. This kind of transformation essentially consumes earth resource (such as coal, petroleum, natural gas and so on), and influences natural environment (such as greenhouse effect, acid rain and so on). Therefore, how to decrease electricity consumption for reducing natural resource consumption is the most important topic in nowadays.

In all electricity application, electricity consumption of illumination often occupies more than half of all electricity consumption. In other words, if electricity consumption of illumination can be effectively reduced, electricity demand can be decreased largely, so as to achieve a goal of reducing electricity consumption and lowering carbon.

In the prior art, reducing electricity consumption of a lighting system can be divided into two categories. The first category is using sensors, such as light sensor or biological sensor (infrared sensor, supersonic wave sensor and so on). The light sensors can sense sunlight intensity, so the lighting system can control twinkle states of lighting devices. However, the light sensors are only suitable for some regions, such as outdoors, nearby windows, etc., which can be illuminated by the sunlight. The biological sensors can sense human body heat or movement, so as to control twinkle states of lighting devices. However, a sensing distance of this kind of sensor is limited (about 14 meters), and after surpassing the sensing distance, the lighting system is unable to detect a user's movement. Therefore, the sensors are added to require the demand, and thus increasing the cost of the light system. Also, additional sensors and corresponding circuit lines cost extra expense, time, and effort-consuming.

Another category is to turn on or turn off lighting devices in a certain area in a scheduled time via computer software or settings of a central supervisor system, to co-operate with a work or rest demand. However, this way relies on an advanced setting, and is unable to adjust twinkle states of the lighting devices according to the actual using condition. Thereof, electricity consumption cannot be reduced effectively.

Therefore, how to improve shortcomings of the prior art becomes a target for enterprises, to effectively reduce the electricity consumption of illumination, so as to realize the goal of reducing electricity consumption and lowering carbon.

### SUMMARY OF THE INVENTION

Therefore, the present invention is to provide a lighting system and related method capable of reducing electricity consumption.

The present invention discloses a lighting system capable of reducing electricity consumption, which includes a switch device, a mobile communication device and a control device. The switch device is coupled to a plurality of lighting devices, and is used for controlling a twinkle state of each of the plurality of lighting devices according to a control command. The mobile communication device includes a position detection module utilized for detecting a position of the mobile communication device to generate a position data, a light sensing module utilized for sensing luminance in a position of the mobile communication device to generate a light sensing data, a wireless transmission module utilized for wirelessly outputting data, and a first processing module coupled to the light sensing module, the position detection module and the wireless transmission module, and utilized for receiving the position data and the light sensing data, and transmitting the position data and the light sensing data to the air via the wireless transmission module. The control device includes a wireless reception module utilized for wirelessly receiving data outputted from the wireless transmission module, and a second processing module coupled to the wireless reception module and the switch device, and utilized for outputting the control command to the switch device according to the position data and the light sensing data.

The present invention further discloses a method for reducing electricity consumption in a lighting system. The lighting system includes a plurality of lighting devices. The method includes obtaining a position data of a mobile communication device, obtaining a light sensing data of the mobile communication device, and controlling a twinkle state of each of the plurality of lighting devices according to the position data and the light sensing data.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of a lighting system according to an embodiment of the present invention.

FIG. 2 is a schematic diagram of a process according to an embodiment of the present invention.

FIG. 3 is an operation diagram of a lighting system according to an embodiment of the present invention shown in FIG. 1.

### DETAILED DESCRIPTION

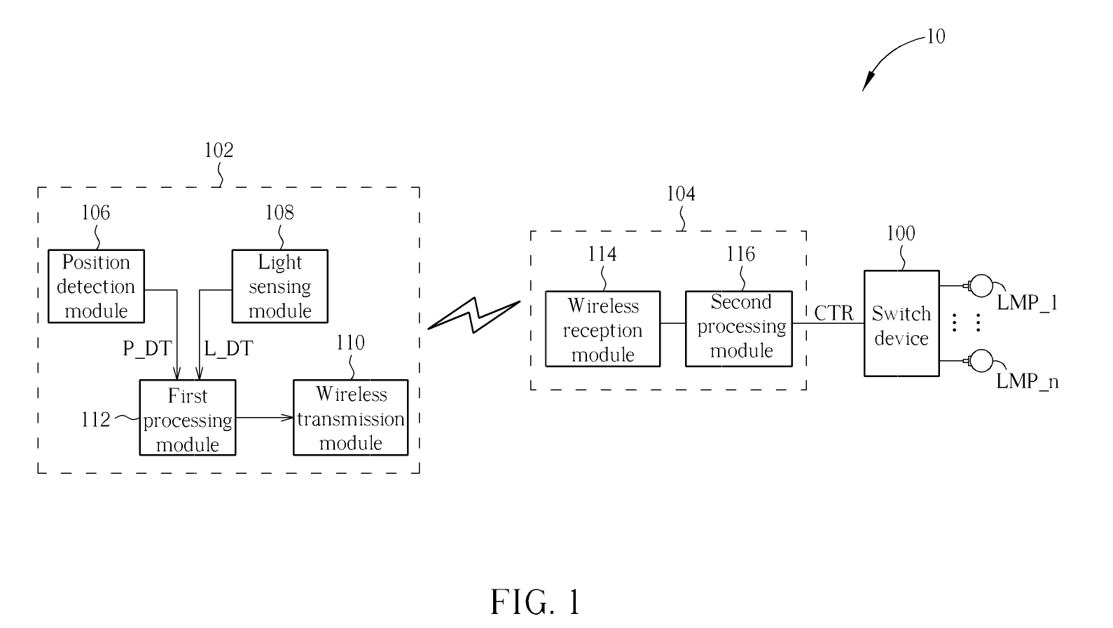

Please refer to FIG. 1, which is a schematic diagram of a lighting system 10 according to an embodiment of the present invention. The lighting system 10 is capable of reducing electricity consumption, which includes a switch device 100, a mobile communication device 102 and a control device 104. The switch device 100 is coupled to lighting devices LMP_1˜LMP_n, and is used for controlling twinkle states of the lighting devices LMP_1˜LMP_n according to a control command CTR generated by the control device 104. The mobile communication device 102 can be a mobile phone or a Personal Digital Assistant, which includes a position detection module 106, a light sensing module 108, a wireless transmission module 110, and a first processing module 112. The position detection module 106 is preferably an Assistant Global Positioning System receiver, and is utilized for detecting a position of the mobile communication device 102 to generate a position data P_DT to the first processing module 112. The light sensing module 108 is utilized for sensing luminance in a position of the mobile communication device 102 to generate a light sensing data L_DT to the first processing module 112. The first processing module 112 is utilized for receiving the position data P_DT and the light sensing data L_DT, and wirelessly transmitting the position data P_DT and the light sensing data L_DT to the control device 104 via the wireless transmission module 110. The control device 104 includes a wireless reception module 114 and a second processing module 116. The wireless reception module 114 is utilized for wirelessly receiving the position data P_DT and the light sensing data L_DT outputted from the wireless transmission module 110, and then the second processing module 116 can output the control command CTR to the switch device 100, so as to control twinkle states of the lighting devices LMP_1˜LMP_n.

In a word, the mobile communication device 102 obtains the position data P_DT and the light sensing data L_DT through the position detection module 106 and the light sensing module 108, and transmits the position data P_DT and the light sensing data L_DT to the control device 104 through the wireless transmission module 110. In this situation, the second processing module 116 of the control device 104 determines location information and luminance information corresponding to a position of the mobile communication device 102 according to the position data P_DT and the light sensing data L_DT, so as to control the lighting devices LMP_1˜LMP_n and adjust a twinkle state in the position of the mobile communication device 102. In other words, in the lighting system 10, a user brings the mobile communication device 102, and then the control device 104 can turn on, turn off, increase or decrease luminance of the lighting devices in the user's position at proper time, so as to reduce electricity consumption.

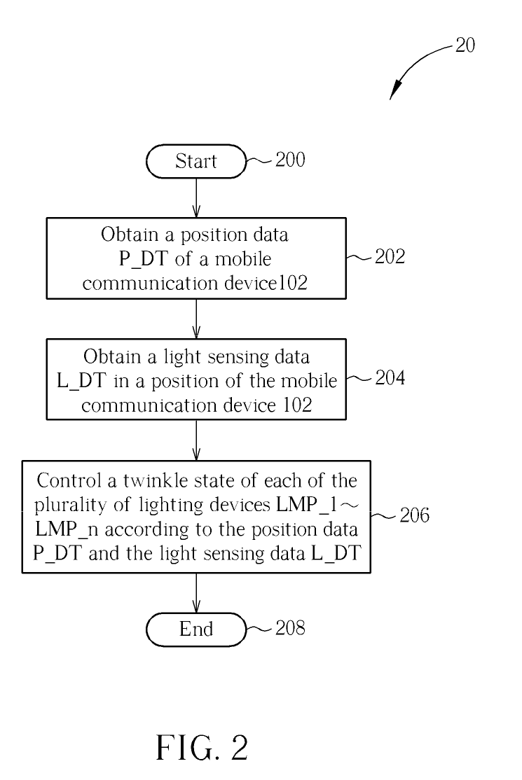

An operation method related to the control device 104 can be concluded to a process 20 as shown in FIG. 2. The process 20 includes the following steps.

Step 200: Start.

Step 202: Obtain a position data P_DT of a mobile communication device 102.

Step 204: Obtain a light sensing data L_DT in a position of the mobile communication device 102.

Step 206: Control a twinkle state of each of the plurality of lighting devices LMP_1˜LMP_n according to the position data P_DT and the light sensing data L_DT.

Step 208: End.

Therefore, the lighting system 10 is not limited by limitations of the light sensor or the biological sensor (such as location limitation and sensing distance limitation), and can adjust twinkle states of the lighting devices according to the actual use condition. Thereby, a shortcoming of the central supervisor system according to the prior art can be improved. Meanwhile, an expansion of the lighting system 10 (such as adding lighting devices) will not increase cost.

In the lighting system 10, the control device 104 adjusts twinkle states of the lighting devices according to a position of the mobile communication device 102 and corresponding luminance. Note that, a method of the control device 104 adjusting the lighting devices LMP_1˜LMP_n is not limited in a certain skill. For example, when the mobile communication device 102 enters an area (such as a parking lot or an office), the second processing module 116 of the control device 104 outputs the control command CTR to the switch unit 100 according to the position data P_DT and the light sensing data L_DT, to increase luminance of the lighting devices corresponding to the area. On the contrary, when the mobile communication device 102 leaves the area, the second processing module 116 can decrease luminance of the lighting devices corresponding to the area through the control command CTR. In other words, the control device 104 can increase or decrease luminance of the lighting devices when the user brings the mobile communication device 102 enters or leaves a certain area, to avoid unnecessary electricity consumption.

In different environments or areas, luminance required by the user may be different. For example, the lighting devices needs to be brighter in a study room or office, but needs to be darker in a presentation meeting. In this situation, a setup module (not shown in FIG. 1) can be included in the mobile communication device 102 for setting a luminance threshold in a certain area, meaning environment luminance that the user demands. Also, a storage module (not shown in FIG. 1) can be included in the control device 104 for storing the luminance threshold. In this situation, when the mobile communication device 102 enters the certain area, the second processing module 116 of the control device 104 compares the luminance in the position of the mobile communication device 102 with the luminance threshold, and adjusts the lighting devices. For example, when the luminance in the position of the mobile communication device 102 is lower than the luminance threshold, luminance of the lighting device is increased, and when the luminance in the position of the mobile communication device 102 is higher than the luminance threshold, luminance of the lighting device is decreased.

Therefore, the control device 104 can adjust a twinkle state of a certain lighting device through the position data P_DT and the light sensing data L_DT, to avoid unnecessary electricity consumption. Meanwhile, the control device 104 can adjust luminance of the lighting device according to different areas or user's demands, to increase convenience.

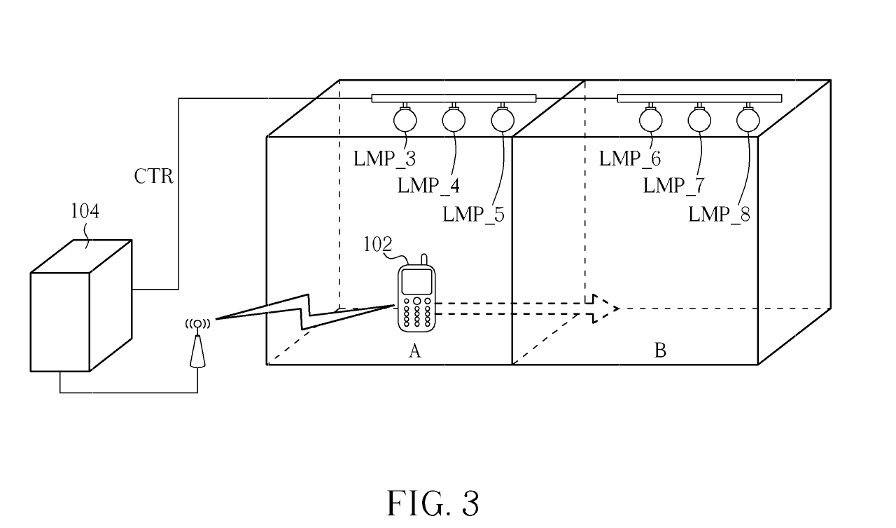

In order to clearly describe the spirit of the present invention, please refer to FIG. 3, which is an operation diagram of the lighting system 10 according to an embodiment of the present invention. In FIG. 3, the user brings the mobile communication device 102 from an area A to an area B, where the lighting source in the area A is lighting devices LMP_3˜LMP_5, and the lighting source in the area B is lighting devices LMP_6˜LMP_8. When the mobile communication device 102 in the area A, the mobile communication device 102 wirelessly transmits the position data P_DT and the light sensing data L_DT to the control device 104 which can determine that a position of the mobile communication device 102 is in the area A, and determine whether luminance in the area A conforms to a demand, so as to control luminance of the lighting devices LMP_3˜LMP_5. When the user brings the mobile communication device 102 from the area A to area B, the control device 104 can notice a position changing of the mobile communication device 102 according to the position data P_DT and the light sensing data L_DT, to turn on or increase luminance of the lighting devices LMP_6˜LMP_8, and turn off the lighting device LMP_3˜LMP_5 in the area A. Therefore, in FIG. 3, the lighting system 10 can adjust twinkle states of the lighting devices LMP_3˜LMP_5 and the lighting devices LMP_6˜LMP_8 according to the user's position, so as to reduce electricity consumption, and increase utilization convenience.

Therefore, switching of the lighting devices LMP_1˜LMP_n becomes more efficiency through the lighting system 10. It not only reduces electricity consumption, but also enhances utilization convenience. Note that, the lighting system 10 shown in FIG. 1 is an embodiment of the present invention. In practice, quantities and implements of each device can be modified and alternated accordingly, and are not limited in the embodiment shown in FIG. 1.

In conclusion, the present invention adjusts the lighting devices according to the position data and the light sensing data corresponding to a position of the mobile communication device, to avoid unnecessary electricity consumption, and enhance utilization convenience.

Those skilled in the art will readily observe that numerous modifications and alterations of the device and method may be made while retaining the teachings of the invention.

What is claimed is:

1. A lighting system capable of reducing electricity consumption comprising:
a switch device, coupled to a plurality of lighting devices, for controlling a twinkle state of each of the plurality of lighting devices according to a control command;
a mobile communication device comprising:
a position detection module, for detecting a position of the mobile communication device to generate a position data;
a light sensing module, for sensing luminance in a position of the mobile communication device, to generate a light sensing data;
a wireless transmission module, for wirelessly outputting data; and
a first processing module, coupled to the light sensing module, the position detection module and the wireless transmission module, for receiving the position data and the light sensing data, and transmitting the position data and the light sensing data to via the wireless transmission module; and
a control device comprising:
a wireless reception module, for wirelessly receiving the position data and the light sensing data outputted from the wireless transmission module; and
a second processing module, coupled to the wireless reception module and the switch device, for outputting the control command to the switch device according to the position data and the light sensing data.

2. The lighting system of claim 1, wherein the position detection module is an Assistant Global Positioning System receiver.

3. The lighting system of claim 1, wherein the second processing module outputs the control command to the switch device according to the position data and the light sensing data when the mobile communication device enters an area, to increase luminance of a lighting device corresponding to the area.

4. The lighting system of claim 1, wherein the second processing module outputs the control command to the switch device according to the position data and the light sensing data when the mobile communication device leaves an area, to decrease luminance of a lighting device corresponding to the area.

5. The lighting system of claim 1, wherein the second processing module compares the luminance in the position of the mobile communication device with a luminance threshold according to the position data and the light sensing data, to output the control command to the switch device.

6. The lighting system of claim 5, wherein the second processing module outputs the control command to the switch device to increase luminance of a lighting device corresponding to the position of the mobile communication device when the luminance in the position of the mobile communication device is lower than the luminance threshold.

7. The lighting system of claim 5, wherein the second processing module outputs the control command to the switch device to decrease luminance of a lighting device corresponding to the position of the mobile communication device when the luminance in the position of the mobile communication device is higher than the luminance threshold.

8. The lighting system of claim 5, wherein the mobile communication device further comprises a setup module for setting the luminance threshold.

9. The lighting system of claim 5, wherein the control device further comprises a storage module for storing the luminance threshold.

10. The lighting system of claim 1, wherein the mobile communication device is a Personal Digital Assistant.

11. A method for reducing electricity consumption in a lighting system comprising a plurality of lighting devices, the method comprising:
obtaining a position data of a mobile communication device;
obtaining a light sensing data of the mobile communication device; and
controlling a twinkle state of each of the plurality of lighting devices according to the position data and the light sensing data.

12. The method of claim 11, wherein obtaining the position data of the mobile communication device is obtaining the position data of the mobile communication via an Assistant Global Positioning System.

13. The method of claim 11, wherein controlling the twinkle state of each of the plurality of lighting devices according to the position data and the light sensing data is increasing luminance of a lighting device corresponding to an area according to the position data and the light sensing data when the mobile communication device enters the area.

14. The method of claim 11, wherein controlling the twinkle state of each of the plurality of lighting devices according to the position data and the light sensing data is decreasing luminance of a lighting device corresponding to an area according to the position data and the light sensing data when the mobile communication device leaves the area.

15. The method of claim 11, wherein controlling the twinkle state of each of the plurality of lighting devices according to the position data and the light sensing data is comparing luminance in a position of the mobile communication device with a luminance threshold according to the position data and the light sensing data, to control the twinkle state of each of the plurality of lighting devices.

16. The method of claim 15, wherein controlling the twinkle state of each of the plurality of lighting devices according to the position data and the light sensing data is increasing luminance of a lighting device corresponding to the position of the mobile communication device when the luminance in the position of the mobile communication device is lower than the luminance threshold.

17. The method of claim 15, wherein controlling the twinkle state of each of the plurality of lighting devices according to the position data and the light sensing data is decreasing luminance of a lighting device corresponding to the position of the mobile communication device when the luminance in the position of the mobile communication device is higher than the luminance threshold.

18. The method of claim 15 further comprises setting the luminance threshold.

19. The method of claim 15 further comprises storing the luminance threshold.

20. The method of claim 11, wherein the mobile communication device is a Personal Digital Assistant.
